(19) United States
(12) Patent Application Publication
(10) Pub. No.: US 2004/0157720 A1
(43) Pub. Date: Aug. 12, 2004

(54) Crystallized glass

(75) Inventors: Akihiko Sakamoto, Kouka-gun (JP); Hideki Asano, Kusatsu-shi (JP)

Correspondence Address: WILLIAM COLLARD, COLLARD & ROE, P.C., 1077 NORTHERN BOULEVARD, ROSLYN, NY, 11576, US

(73) Assignee: NIPPON ELECTRIC GLASS CO., LTD.

(21) Appl. No.: 10/643,535

(22) Filed: Aug. 19, 2003

(30) Foreign Application Priority Data
Aug. 20, 2002 (JP) 238990/2002

(51) Int. Cl. C03C 10/14; C03C 10/12

(52) U.S. Cl. 501/4; 65/33.8; 501/7

(57) ABSTRACT

Crystallized glass is formed by precipitating β-spodumene solid solution or β-quartz solid solution, and contains, by mass percent, 55-72% SiO₂, 14-30% Al₂O₃, 2.9-6.0% Li₂O, and 1.0-10.0% K₂O, wherein a mass ratio between Li₂O and K₂O (Li₂O/K₂O) is 2.2 or less.

The present invention claims priority to prior Japanese patent application 2002-238990, the disclosure of which is incorporated herein by reference.

### BACKGROUND OF THE INVENTION

The present invention relates to crystallized glass that can be redrawn, and further relates to a crystallized glass article using such crystallized glass.

Crystallized glass is a material that exhibits, owing to various crystals precipitated in glass, unique properties which the glass does not have. For example, when crystals of β-quartz solid solution or β-spodumene solid solution are precipitated, crystallized glass exhibiting a low thermal expansion or a negative thermal expansion, which glass does not exhibit, is obtained. Further, the crystallized glass generally has a mechanical strength higher than glass due to the presence of those crystals.

In recent years, it has been proposed to redraw the crystallized glass having such excellent properties into the precise shape of a thin rod, a thin tube, a thin plate, or the like, and apply it to an electronic component, a precision machine component, or the like, which has been put to practical use. In general, since mother glass of the crystallized glass is so designed in composition as to be crystallized by heating, crystals are precipitated by heating upon redrawing, and therefore, a precise product can not be formed. For solving this problem, improved techniques of redrawing the crystallized glass have been developed to thereby enable precise redrawing of the crystallized glass. Such techniques are disclosed in, for example, JP-A-H09-086961 and JP-A-2002-154840.

In the redrawable crystallized glass described in those publications, however, since the viscosity of mother glass is high, the mother glass is required to be melted at a high temperature for obtaining homogeneous glass with no cords, and hence, deterioration of a furnace and its equipment is significant so that it is difficult to improve productivity.

On the other hand, if the content of Li₂O as a mother glass component is increased for lowering the viscosity of the mother glass to thereby melt the mother glass at a lower temperature, the amount of crystal precipitation increases to raise a softening point of the crystallized glass so that a redrawing temperature becomes higher than a melting point of precipitated crystals to cause occurrence of melting and reprecipitation of crystals upon redrawing. Therefore, there has been a problem that dimensional accuracy of a redrawn product is lowered and, in the worst case, the redrawing can not be performed.

### SUMMARY OF THE INVENTION

It is an object of the present invention to provide crystallized glass that can suppress increase in amount of crystal precipitation to prevent a rise of a softening point of the crystallized glass even when a mother glass thereof contains a large amount of Li₂O which is highly effective for lowering a viscosity of the mother glass to enable melting thereof at a lower temperature, thereby to be redrawable with high precision, and further provide a crystallized glass article using such crystallized glass.

The present inventors have found that even if a mother glass contains a large amount of Li₂O , the mother glass can be melted at a lower temperature and yet highly precise redrawing can be achieved by controlling a mass ratio between Li₂O and K₂O (Li₂O/K₂O), and have come to propose the present invention.

Specifically, crystallized glass of the present invention is formed by precipitating β-spodumene solid solution or β-quartz solid solution, and contains, by mass percent, 55-72% SiO₂, 14-30% Al₂O₃, 2.9-6.0% Li₂O, and 1.0-10.0% K₂O, wherein a mass ratio between Li₂O and K₂O (Li₂O/K₂O) is 2.2 or less.

Further, a crystallized glass article of the present invention is obtained by redrawing crystallized glass that is formed by precipitating β-spodumene solid solution or β-quartz solid solution, and contains, by mass percent, 55-72% SiO₂, 14-30% Al₂O₃, 2.9-6.0% Li₂O, and 1.0-10.0% K₂O, wherein a mass ratio between Li₂O and K₂O (Li₂O/K₂O) is 2.2 or less.

As described above, according to the crystallized glass of the present invention, even if the content of Li₂O is large, a softening point thereof is not raised to enable highly precise redrawing, and further, a viscosity of a mother glass can be lowered to thereby suppress deterioration of a furnace and its equipment, improve productivity, facilitate obtaining homogeneous mother glass, and thus increase yield of redrawn products.

Furthermore, since the softening point of the crystallized glass is not only prevented from rising, but lowered, to be precise, a temperature upon redrawing can be lowered so that deterioration of the redrawing facilities can be suppressed to improve the productivity of redrawing.

Moreover, the crystallized glass article obtained by redrawing the crystallized glass of the present invention is applicable to an optical connector, an information communication component such as a fixed attenuator, or an electronic component.

### DESCRIPTION OF THE PREFERRED EMBODIMENT

Crystallized glass of the present invention is formed by precipitating β-spodumene solid solution or β-quartz solid solution, and contains, by mass percent, 55-72% SiO₂, 14-30% Al₂O₃, 2.9-6.0% Li₂O, and 1.0-10.0% K₂O, wherein a mass ratio between Li₂O and K₂O (Li₂O/K₂O) is 2.2 or less. Therefore, even if the content of Li₂O is large to thereby melt a mother glass at a lower temperature, a softening point of the crystallized glass is not raised to enable redrawing thereof with high accuracy, and further, a lower viscosity of the mother glass can be achieved. When the viscosity of the mother glass is low, homogeneous glass with no cords can be obtained even if the mother glass is melted at a low temperature. Hence, deterioration of a furnace and its equipment is not liable to occur so that the productivity is improved. Further, since the softening point of the crystallized glass is not only prevented from rising, but lowered, to be specific, a temperature upon the redrawing can be lowered so that deterioration of the redrawing facilities can be suppressed to improve the productivity of the redrawing.

Moreover, the crystallized glass of the present invention is composed of precipitated β-spodumene solid solution or β-quartz solid solution with a low thermal expansion coefficient, and has a thermal expansion coefficient of −10×10⁻⁷ to 50×10⁻⁷/° C. (preferably −5×10⁻⁷ to 35 ×10⁻⁷/° C.) within the range of −50 to 150° C. Therefore, dimensional variation caused by temperature variation is small, and hence, when it is used as a precision component, misalignment is reluctant to occur even if the temperature changes. Further, when used as a material of a ferrule, dimensional variations of an optical fiber and the ferrule are substantially equal to each other even if the temperature changes, so that an initial connection characteristic is reluctant to be deteriorated. Incidentally, the thermal expansion coefficient of an optical fiber made of quartz glass is 5.5×10⁻⁷/° C. within the range of −50 to 150° C.

Reasons for defining the ratios of the respective components in the crystallized glass of the present invention are as follows.

SiO₂ is a main component of the glass and also a crystal component. When the content of SiO₂ is less than 55%, the viscosity of the glass can be lowered, however, coarse crystals are precipitated to make it difficult to implement the redrawing with high accuracy. On the other hand, the content of SiO₂ greater than 72% raises the softening point of the crystallized glass and deteriorates the meltability upon melting the glass.

Al₂O₃ is also a crystal component like SiO₂. When the content of Al₂O₃ is less than 14%, coarse crystals are precipitated to make it difficult to implement the redrawing with high accuracy. On the other hand, when the content of Al₂O₃ is greater than 30%, devitrification is liable to occur upon redrawing the crystallized glass.

Li₂O is essential as a crystal component and is also an important component for lowering the viscosity of the mother glass to enable melting thereof at a low temperature. Further, it is also a component for improving the meltability of SnO₂. If the content of Li₂O is 2.9% or more, the viscosity of the mother glass can be lowered. Therefore, even if the mother glass is melted at a low temperature, it is possible to obtain homogeneous glass without cords. Furthermore, if the content of Li₂O is 2.9% or more, a surface compressive stress caused by ion exchange with K₂O increases to enhance a mechanical strength (flexural strength) of a crystallized glass article. On the other hand, when the content of Li₂O is less than 2.9%, the viscosity of the mother glass increases, and therefore, unless the mother glass is melted at a high temperature, cords are generated to thereby reduce the productivity. When the content of Li₂O is greater than 6.0%, a propensity for crystallization becomes too strong, and therefore, devitrification is liable to occur upon forming the mother glass, and further, the softening point of the crystallized glass is raised. The content of Li₂O is preferably 2.9 to 4.5%, and more preferably 4.1 to 4.5%.

K₂O is an essential component for controlling the propensity for crystallization and exerts a serious influence upon the ratio of a glass phase, the softening point, and the viscosity of the glass after the crystallization. Specifically, when the content of K₂O is less than 1.0%, the propensity for crystallization becomes too strong to thereby lower the ratio of the glass phase, while raise the softening point of the crystallized glass. On the other hand, when the content of K₂O exceeds 10.0%, different kinds of crystals tend to be precipitated. K₂O further exerts a significant influence upon an adding amount of Li₂O. Specifically, since the propensity for crystallization can be controlled by adding K₂O, the ratio of the glass phase can be prevented from becoming too low even if a larger amount of Li₂O is added. Thus, it is possible to facilitate the low-temperature melting of the mother glass owing to lowering of the viscosity thereof, and simultaneously, to maintain the redraw-formability, i.e. the redrawability, of the crystallized glass.

Therefore, when the mass ratio between Li₂O and K₂O is 2.2 or less, crystal precipitation does not increase even if the content of Li₂O is increased, so that the softening point of the crystallized glass does not rise to thereby enable highly precise redrawing thereof, and further, the crystallized glass can be excellent in mechanical strength and abrasion resistance, and the lowered viscosity of the mother glass can be achieved. Further, since the softening point of the crystallized glass is not only prevented from rising, but lowered, to be specific, the temperature upon the redrawing can be lowered so that deterioration of the redrawing facilities can be suppressed to improve the productivity of the redrawing. On the other hand, when the mass ratio between Li₂O and K₂O is less than 0.33, different kinds of crystals tend to be precipitated, which is thus not preferable.

The mass ratio between Li₂O and K₂O is preferably 0.33 to 2.2, and more preferably 0.5 to 1.5.

Further, the crystallized glass having the foregoing composition has a relatively high Li ion concentration in the glass phase, and thus there is also a merit that the mechanical strength based on ion exchange is liable to be improved.

A specific composition of the crystallized glass of the present invention contains, by mass percent, 55-72% SiO₂, 14-30% Al₂O₃, 2.9-6.0% Li₂O, 1.0-10.0% K₂O, 1.0-5.0% TiO₂, 0-4.0% ZrO₂, 2.0-9.0% TiO₂+ZrO₂, 0-10.0% ZnO, 0-2.5% MgO, 0-4.0% CaO, 0-6.0% BaO, 0-7.0% B₂O₃, 0-4.0% Na₂O, and 0-8.0% P₂O₅.

Reasons for defining the ratios of the foregoing components other than the aforementioned main components, i.e. SiO₂, Al₂O₃, Li₂O and K₂O, are as follows.

TiO₂ is a component (nucleating agent) that becomes nuclei upon precipitation of crystals and serves to minimize the grain size of the crystals. When the content of TiO₂ is less than 1.0%, coarse crystals are precipitated to make it difficult to implement the redrawing with high accuracy. On the other hand, when the content of TiO₂ is greater than 5.0%, devitrification tends to occur upon forming the mother glass. The content of TiO₂ is preferably 1.5 to 4.0%.

Like TiO₂, ZrO₂ is also a component (nucleating agent) that becomes nuclei upon precipitation of crystals. When the content of ZrO₂ is greater than 4%, devitrification tends to occur upon melting the glass. The content of ZrO₂ is preferably 1.0 to 3.0%.

When the total amount of TiO₂ and ZrO₂ is less than 2.0%, the propensity for crystallization is weakened so that it becomes difficult to obtain fine crystals. On the other hand, when the total amount thereof exceeds 9.0%, devitrification tends to occur upon forming the mother glass, and the mother glass tends to be heterogeneous.

Each of ZnO, MgO, CaO, BaO, B₂O₃, and Na₂O is a component effective for lowering the softening point of the crystallized glass. 0-10.0% ZnO (preferably 1.5-6.0%), 0-2.5% MgO (preferably 0-2.0%), 0-4.0% CaO (preferably 0-2.0%), 0-6.0% BaO (preferably 0-3.5%), 0-7.0% B₂O₃ (preferably 0-5%), 0-4.0% Na₂O (preferably 0-2.0%), and 0-8.0% P₂O₅ (preferably 0-4%) can be added. If these ranges are exceeded, different kinds of crystals tend to be precipitated and devitrification increases.

Other than the foregoing components, SnO₂ can be added up to 3.0% (preferably 0.1-3.0%) for the purpose of improving clarification upon melting the glass. Since SnO₂ is a component exhibiting reluctance in melting, if the content thereof is greater than 3.0%, it becomes difficult to melt the glass.

Other components such as As₂O₃, Sb₂O₃, PbO, and Bi₂O₃ can also be contained within the range not exceeding 500 ppm, and platinum may be contained within the range not exceeding 30 ppm.

It is preferable that the crystallized glass of the present invention has a crystal grain size equal to or less than 10 μm (preferably 5 μm or less). When the crystal grain size exceeds 10 μm, elongation of the crystallized glass upon redrawing decreases considerably resulting in deterioration of the dimensional accuracy, and the material property such as mechanical strength, abrasion resistance or chemical durability tends to be deteriorated.

Further, it is preferable that the ratio of the glass phase is 10 to 85 vol % (preferably 20 to 65 vol %) in the crystallized glass of the present invention. When the glass phase is less than 10 vol %, the redrawing tends to be difficult, while, when it is greater than 85 vol %, the crystal amount is reduced so that the mechanical strength and the abrasion resistance tend to be lowered.

Furthermore, it is preferable that the crystallized glass of the present invention has a softening point which is lower than a melting point of predominant precipitated crystals. Specifically, when the softening point is lower than the melting point, the redrawing temperature can be set to a value lower than the melting point so that it is possible to perform the redrawing while the crystals remain, and therefore, a redrawn product can substantially maintain characteristics as the crystallized glass. The softening point and the melting point of the crystallized glass can be measured according to a differential thermal analysis (DTA).

Moreover, it is preferable that even when heated at a temperature equal to or higher than the softening point, crystallization does not substantially progress in the crystallized glass of the present invention. Specifically, since the surface newly produced by the redrawing has free energy higher than that of the inside, when the crystallized glass is heated to the temperature equal to or higher than the softening point, crystallization tends to progress so that coarse crystals (devitrification) are concentratedly precipitated on the surface. This makes the redrawing difficult and largely deteriorates the dimensional accuracy or material property of a redrawn product. In the present invention, the foregoing “crystallization does not substantially progress” means, to be specific, that even when heated and held at the temperature equal to or higher than the softening point, the crystal phase only increases by less than 15 vol %.

Further, it is preferable that the crystallized glass of the present invention is formed from a mother glass exhibiting a viscosity of 10⁴ Pa·s at a temperature equal to or less than 1330° C. If a temperature at which the viscosity of 10⁴ Pa·s is exhibited is higher than 1330° C., the mother glass should be melted at a high temperature for obtaining homogeneous glass free of cords and hence the furnace and its equipment are liable to be deteriorated, which is thus not preferable. On the other hand, if the mother glass is melted at a low temperature for suppressing deterioration of the furnace and its equipment, the homogeneous glass free of cords can not be obtained and the redrawability upon redrawing the crystallized glass becomes poor.

### EXAMPLE

Hereinbelow, the crystallized glass of the present invention will be described based on examples.

Tables 1 and 2 show examples (samples Nos. 1 to 10) of the present invention, while Table 3 shows comparative examples (samples Nos. 11 to 14).

TABLE 1

| | Sample No. | | | | |
|---|---|---|---|---|---|
| | Example | | | | |
| Mass % | 1 | 2 | 3 | 4 | 5 |
| SiO₂ | 62.8 | 66.4 | 66.0 | 64.0 | 63.0 |
| Al₂O₃ | 18.4 | 18.4 | 18.3 | 19.3 | 17.0 |
| Li₂O | 3.6 | 3.6 | 3.0 | 4.0 | 5.5 |
| K₂O | 5.0 | 3.4 | 3.4 | 3.4 | 6.5 |
| TiO₂ | 3.6 | 3.0 | 3.0 | 3.0 | 2.0 |
| ZrO₂ | 1.5 | 1.8 | 1.8 | 0.8 | 2.0 |
| ZnO | 3.1 | 1.5 | 2.2 | 2.2 | — |
| MgO | 1.0 | 1.0 | 1.0 | 1.5 | 0.5 |
| CaO | — | — | — | 0.5 | 1.0 |
| BaO | 1.0 | 0.5 | 0.7 | 0.7 | 1.0 |
| Na₂O | — | — | — | — | 0.5 |
| As₂O₃ | — | 0.4 | 0.6 | 0.6 | — |
| Sb₂O₃ | — | — | — | — | — |
| SnO₂ | — | — | — | — | 1.0 |
| Li₂O/K₂O | 0.72 | 1.06 | 0.88 | 1.18 | 0.85 |
| Melting Temperature | 1500 | 1500 | 1500 | 1500 | 1500 |
| (° C.) | | | | | |
| Viscosity | 1240 | 1260 | 1270 | 1220 | 1200 |
| (° C., @ 10⁴ Pa · s) | | | | | |
| Cords | no | no | no | no | no |
| Crystallization | 1000 | 1000 | 1000 | 1000 | 900 |
| Temperature (° C.) | | | | | |
| Thermal Expansion | 33 | 24 | 25 | 22 | 6 |
| Coefficient | | | | | |
| (×10⁻⁷/° C.) | | | | | |
| Type of Predominant | S | S | S | S | Q |
| Crystal | | | | | |
| Crystal Grain Size (μm) | 0.5 | 0.5 | 0.5 | 1.5 | 0.3 |
| Glass Phase Ratio (%) | 55 | 45 | 50 | 40 | 50 |
| Glass Phase Ratio after | 65 | 50 | 60 | 45 | 55 |
| heating (%) | | | | | |
| Melting Point (° C.) | 1210 | 1220 | 1210 | 1220 | 1200 |
| Softening Point (° C.) | 1100 | 1130 | 1120 | 1120 | 1080 |
| Redrawing Temperature | 1130 | 1150 | 1140 | 1140 | 1110 |
| (° C.) | | | | | |
| Redrawability | good | good | good | good | good |

TABLE 2

| | Sample No. | | | | |
|---|---|---|---|---|---|
| | Example | | | | |
| Mass % | 6 | 7 | 8 | 9 | 10 |
| SiO₂ | 66.5 | 64.1 | 61.0 | 65.7 | 66.0 |
| Al₂O₃ | 18.4 | 20.1 | 21.0 | 18.0 | 17.5 |
| Li₂O | 4.5 | 3.6 | 5.6 | 3.0 | 3.0 |
| K₂O | 4.0 | 2.4 | 7.0 | 4.7 | 6.0 |
| TiO₂ | 3.0 | 3.5 | 3.5 | 3.5 | 3.0 |
| ZrO₂ | 2.0 | 1.5 | 1.5 | 1.5 | 1.7 |
| ZnO | 1.0 | 2.0 | — | 1.9 | 1.0 |
| MgO | — | 1.0 | — | 0.5 | — |
| CaO | — | — | — | — | — |
| BaO | — | 1.0 | — | 0.8 | 0.5 |
| Na₂O | — | — | — | — | 0.5 |
| As₂O₃ | — | — | — | — | 0.8 |
| Sb₂O₃ | — | 0.8 | — | — | — |
| SnO₂ | 0.6 | — | 0.4 | 0.4 | — |
| Li₂O/K₂O | 1.13 | 1.50 | 0.88 | 0.64 | 0.50 |
| Melting Temperature | 1500 | 1500 | 1500 | 1500 | 1500 |
| (° C.) | | | | | |
| Viscosity | 1220 | 1260 | 1200 | 1330 | 1270 |
| (° C., @ 10⁴ Pa · s) | | | | | |
| Cords | no | no | no | no | no |
| Crystallization | 1000 | 1000 | 880 | 1000 | 1000 |
| Temperature (° C.) | | | | | |
| Thermal Expansion | 22 | 27 | 10 | 26 | 30 |
| Coefficient (×10⁻⁷/° C.) | | | | | |
| Type of Predominant | S | S | Q | S | S |
| Crystal | | | | | |
| Crystal Grain Size (μm) | 1.5 | 0.5 | 0.5 | 0.5 | 0.5 |
| Glass Phase Ratio (%) | 50 | 55 | 45 | 55 | 60 |
| Glass Phase Ratio after | 60 | 65 | 55 | 65 | 70 |
| heating (%) | | | | | |
| Melting Point (° C.) | 1210 | 1200 | 1220 | 1210 | 1210 |
| Softening Point (° C.) | 1130 | 1140 | 1070 | 1130 | 1120 |
| Redrawing Temperature | 1150 | 1160 | 1100 | 1160 | 1150 |
| (° C.) | | | | | |
| Redrawability | good | good | good | good | good |

TABLE 3

| | Sample No. | | | |
|---|---|---|---|---|
| | Comparative Example | | | |
| Mass % | 11 | 12 | 13 | 14 |
| SiO₂ | 65.5 | 66.5 | 66.5 | 70.0 |
| Al₂O₃ | 20.5 | 18.4 | 18.4 | 14.0 |
| Li₂O | 4.0 | 2.3 | 2.3 | 4.5 |
| K₂O | 1.4 | 2.4 | 2.4 | 2.0 |
| TiO₂ | 1.2 | 3.6 | 3.6 | 2.0 |
| ZrO₂ | 1.8 | 1.5 | 1.5 | 1.8 |
| ZnO | 3.1 | 3.1 | 3.1 | 2.0 |
| MgO | 1.0 | 1.0 | 1.0 | 0.5 |
| CaO | — | — | — | — |
| BaO | 1.0 | 1.0 | 1.0 | 1.9 |
| Na₂O | — | — | — | — |
| As₂O₃ | 0.5 | — | — | 1.3 |
| Sb₂O₃ | — | — | — | — |
| SnO₂ | — | 0.2 | 0.2 | — |
| Li₂O/K₂O | 2.90 | 0.96 | 0.96 | 2.25 |
| Melting Temperature (° C.) | 1500 | 1500 | 1600 | 1500 |
| Viscosity (° C., @ 10⁴ Pa · s) | 1270 | 1360 | 1360 | 1280 |
| Cords | no | yes | no | no |
| Crystallization Temperature | 1000 | 1000 | 1000 | 1000 |
| (° C.) | | | | |
| Thermal Expansion Coefficient | 25 | 22 | 22 | 28 |
| (×10⁻⁷/° C.) | | | | |
| Type of Predominant Crystal | S | S | S | S |
| Crystal Grain Size (μm) | 2.5 | 0.5 | 0.5 | 3.0 |
| Glass Phase Ratio (%) | 25 | 50 | 50 | 30 |
| Glass Phase Ratio after | 35 | 60 | 60 | 35 |
| heating (%) | | | | |
| Melting Point (° C.) | 1230 | 1210 | 1210 | 1230 |
| Softening Point (° C.) | 1190 | 1170 | 1170 | 1180 |
| Redrawing Temperature (° C.) | 1240 | 1200 | 1200 | 1240 |
| Redrawability | no | no | good | no |
| | good | good | | good |

First, glass materials prepared to have compositions shown in Tables 1 to 3 were put into platinum crucibles which were then placed in a glass melt furnace. After melting them at melting temperatures shown in Tables for ten hours while stirring them, the molten glass was cast into cylindrical shapes each having a diameter of 50 mm and a length of 500 mm, thereby to prepare mother glass cast products.

The mother glass cast products each contained 40-100 ppm Fe₂O₃ that was mixed in from raw materials, and further contained 1-3 ppm Pt that was melted in from the platinum crucible.

Evaluation was carried out about viscosity and cords with respect to the obtained mother glass cast products. The viscosity of the mother glass was measured according to a platinum ball lifting method, while the cords were observed with the naked eye by applying light of a halogen lamp onto the mother glass cast products.

Then, the mother glass cast products were heated for four hours at crystallization temperatures shown in Tables by the use of an electric furnace, thereby to be crystallized, so that crystallized glass was prepared.

With respect to each crystallized glass thus obtained, the thermal expansion coefficient, the type of a precipitated crystal, the crystal grain size, the glass phase occupation ratio, the melting point of a precipitated crystal, and the softening point of the crystallized glass were measured. In Tables, S represents β-spodumene solid solution and Q represents β-quartz solid solution.

Then, after heating each crystallized glass for one hour at a temperature that is 70° C. higher than the softening point, or at a temperature that is 50° C. lower than the melting point of the precipitated crystal, the glass phase occupation ratio (ratio after heating) was measured again.

The thermal expansion coefficient was measured in the temperature range of −50 to 150° C. by the use of a dilatometer. The type of the precipitated crystal was identified according to X-ray diffraction (XRD). The crystal grain size and the glass phase occupation ratio were measured by the use of a scanning electron microscope (SEM). The melting point of the precipitated crystal and the softening point of the crystallized glass were measured based on a differential thermal analysis (DTA) for each of samples in the form of powder not greater than 150 mesh.

Then, the periphery of each crystallized glass was ground to improve the roundness by the use of a diamond tool, thereby to prepare a preform having a diameter of 40 mm. Subsequently, the preform was continuously fed into a ring-shaped electric furnace from the above at a speed of 5 mm/min. In this event, a lower end of the preform that was softened and deformed to extend downward was pressed between rollers so as to be drawn into a thin rod having a diameter of 2.5 mm at a speed of 1280 mm/min. Then, the redrawability was evaluated such that when the outer diameter accuracy of the sample after the redrawing was within 2 μm, it was evaluated as “good”, while it was evaluated as “no good” when greater than 2 μm.

As seen from Tables, in each of examples Nos. 1-10 of the present invention, the grain size of the precipitated crystals was small although the content of Li₂O was large, and the viscosity of the mother glass became 10⁴ Pa·s between 1200° C. and 1330° C. and thus was effectively lowered. Further, even when melted at 1500° C., no cords were observed in the glass cast product and the homogeneous glass was obtained, which was excellent in redrawability.

On the other hand, in each of comparative examples Nos. 11-14, while the content of Li₂O was large and the viscosity of the mother glass was low, since the mass ratio of Li₂O/K₂O was greater than 2.2, the softening point after the crystallization was raised so that the redrawing temperature became higher than the melting point, and thus the dimensional accuracy of the redrawn product was low.

In comparative example 12, since the content of Li₂O was small, the viscosity of the mother glass became 10⁴ Pa·s at a temperature higher than 1330° C. and thus was high, and therefore, when melted at 1500° C., cords were observed in the glass cast product. Since the glass is heterogeneous, the redrawability was poor and hence the dimensional accuracy of the redrawn product was largely deteriorated.

It is seen from data of comparative example 13 that if the glass cast product of comparative example 12 is melted at 1600° C., the cords are not observed.

While the present invention has been described in terms of the specific examples, it is readily understood that the present invention is not to be limited thereto, but can be applied to various redrawable crystallized glass and various crystallized glass articles using them and can be further modified in various ways by the person skilled in the art. The crystallized glass article obtained by redrawing the crystallized glass is applicable to an optical connector, an information communication component such as a fixed attenuator, or an electronic component.

What is claimed is:

1. Crystallized glass formed by precipitating β-spodumene solid solution or β-quartz solid solution, and containing, by mass percent, 55-72% SiO₂, 14-30% Al₂O₃, 2.9-6.0% Li₂O, and 1.0-10.0% K₂O, wherein a mass ratio between Li₂O and K₂O (Li₂O/K₂O) is 2.2 or less.

2. Crystallized glass according to claim 1, having a composition containing, by mass percent, 55-72% SiO₂, 14-30% Al₂O₃, 2.9-6.0% Li₂O, 1.0-10.0% K₂O, 1.0-5.0% TiO₂, 0-4.0% ZrO₂, 2.0-9.0% TiO₂+ZrO₂, 0-10.0% ZnO, 0-2.5% MgO, 0-4.0% CaO, 0-6.0% BaO, 0-7.0% B₂O₃, 0-4.0% Na₂O, and 0-8.0% P₂O₅.

3. Crystallized glass according to claim 1, containing, by mass percent, 55-72% SiO₂, 14-30% Al₂O₃, 4.1-6.0% Li₂O, 1.0-10.0% K₂O, 1.0-5.0% TiO₂, 0.1-3.0% SnO₂, 0-4.0% ZrO₂, 2.0-9.0% TiO₂+ZrO₂, 0-10.0% ZnO, 0-2.5% MgO, 0-4.0% CaO, 0-6.0% BaO, 0-7.0% B₂O₃, 0-4.0% Na₂O, and 0-8.0% P₂O₅.

4. Crystallized glass according to claim 1, wherein a grain size of a precipitated crystal is 10 μm or less.

5. Crystallized glass according to claim 1, wherein a ratio of a glass phase is 10-85 vol %.

6. Crystallized glass according to claim 1, wherein a softening point is lower than a melting point of a predominant precipitated crystal.

7. Crystallized glass according to claim 1, wherein crystallization is substantially prevented from progressing even when heated at a temperature equal to or higher than a softening point.

8. A crystallized glass article obtained by redrawing the crystallized glass according to claim 1.

9. Crystallized glass formed by precipitating β-spodumene solid solution or β-quartz solid solution, and containing, by mass percent, 55-72% SiO₂, 14-30% Al₂O₃, 2.9-6.0% Li₂O, and 1.0-10.0% K₂O, wherein a temperature at which a viscosity of a mother glass becomes 10⁴ Pa·s is 1330° C. or less.
